(19) United States
(12) Patent Application Publication
(10) Pub. No.: US 2022/0271640 A1
(43) Pub. Date: Aug. 25, 2022

(54) LINEAR RECIPROCATING DRIVE APPARATUS FOR SECONDARY BATTERY MANUFACTURING PROCESS

(71) Applicant: CLEVER CO., LTD., Chungcheongbuk-do (KR)

(72) Inventors: Jong Hong JEONG, Chungcheongbuk-do (KR); Sang Jin KIM, Daejeon Metropolitan City (KR)

(21) Appl. No.: 17/629,565

(22) PCT Filed: Jul. 24, 2020
(86) PCT No.: PCT/KR2020/009803

§ 371 Date: Jan. 24, 2022

(30) Foreign Application Priority Data
Jul. 24, 2019 (KR) 10-2019-0089874

(51) Int. Cl. H02K 33/18; H02K 7/00; H01M 10/04

(52) U.S. Cl. CPC H02K 33/18; H02K 7/003; H01M 10/0404

(57) ABSTRACT

Disclosed is a linear reciprocating drive apparatus for a secondary battery manufacturing process, the linear reciprocating drive apparatus including a cylinder having therein a column-shaped accommodation portion and including first and second air vents respectively disposed at one side and the other side of the cylinder and configured to communicate with the accommodation portion, a piston disposed in the cylinder and configured to reciprocates between one end and the other end of the accommodation portion, the piston being configured to divide the accommodation portion into two spaces respectively communicating with the first and second air vents, a driving shaft connected to the piston and extending to the outside of the cylinder, the driving shaft being configured to linearly reciprocate as the piston reciprocates in a longitudinal direction of the accommodation portion, and a shock absorbing unit configured to absorb shock by using a repulsive force between magnetic elements.

### TECHNICAL FIELD

The present disclosure relates to a linear reciprocating drive apparatus for a secondary battery manufacturing process, and more particularly, to a linear reciprocating drive apparatus for a secondary battery manufacturing process that has a structure for minimizing the amount of shock generated during a linear reciprocating motion.

### BACKGROUND ART

This section provides background information related to the present disclosure which is not necessarily prior art.

A secondary battery manufacturing process refers to a large-scaled production line for producing secondary battery assemblies having stacked electrode pieces by using band-shaped electrodes and separators.

In particular, there are various unit processes using linear reciprocating driving power during the process of manufacturing secondary battery assemblies divided into pieces from a step of sealing a pouch foil for packaging the electrode assembly to a step of performing an accelerated life test.

Recently, there is a rapidly increasing demand for the secondary batteries, and thus there is a need to improve durability of a linear reciprocating drive apparatus used for the secondary battery manufacturing process.

In addition, as the amount of production of the secondary batteries increases, there have been introduced various technologies for improving the productivity of manufacturing facilities. Therefore, the linear reciprocating drive apparatus is also required to implement stable operational characteristics while operating at high speed.

A general linear reciprocating drive apparatus linearly reciprocates a piston by supplying or discharging air to or from two opposite sides of the piston inserted into a cylinder.

However, during the linear reciprocating motion of the piston, the piston repeatedly collides with two opposite end walls in the cylinder. This collision not only consistently and repetitively transmits noise to the surrounding area, but also causes damage to the cylinder and the piston, which have an adverse effect on durability of the linear reciprocating drive apparatus.

In addition, because of the problem of noise and reduction in lifespan, the linear reciprocating drive apparatus in the related art has a limitation in increasing a reciprocating driving speed, which causes difficulty in shortening secondary battery manufacturing process time.

### SUMMARY

### Technical Problem

An object of the present disclosure is to provide a linear reciprocating drive apparatus for a secondary battery manufacturing process that has a structure for minimizing the amount of shock generated during a linear reciprocating motion.

Another object of the present disclosure is to provide a linear reciprocating drive apparatus for a secondary battery manufacturing process that has a structure for increasing a linear reciprocating speed.

### Technical Solution

This section provides a general summary of the disclosure and is not a comprehensive disclosure of its full scope or all of its features.

One aspect of the present disclosure provides a linear reciprocating drive apparatus for a secondary battery manufacturing process, the linear reciprocating drive apparatus including: a cylinder having therein a column-shaped accommodation portion and including first and second air vents respectively disposed at one side and the other side of the cylinder and configured to communicate with the accommodation portion; a piston disposed in the cylinder and configured to reciprocates between one end and the other end of the accommodation portion, the piston being configured to divide the accommodation portion into two spaces respectively communicating with the first and second air vents; a driving shaft connected to the piston and extending to the outside of the cylinder, the driving shaft being configured to linearly reciprocate as the piston reciprocates in a longitudinal direction of the accommodation portion; and a shock absorbing unit configured to absorb shock by using a repulsive force between magnetic elements when the piston moves toward one end and the other end of the accommodation portion.

In the linear reciprocating drive apparatus for a secondary battery manufacturing process according to one aspect of the present disclosure, the shock absorbing unit may include: first and second magnet members respectively disposed at one end and the other end based on the longitudinal direction of the accommodation portion and having poles having different polarities and facing each other; and a third magnet member provided on the piston, the third magnet member being disposed to have the same polarity as the first magnet member in a direction in which the third magnet member faces the first magnet member, and disposed to have the same polarity as the second magnet member in a direction in which the third magnet member faces the second magnet member.

In the linear reciprocating drive apparatus for a secondary battery manufacturing process according to one aspect of the present disclosure, the shock absorbing unit may include first elastic members configured to fix the first and second magnet members to one end and the other end of the accommodation portion based on the longitudinal direction.

In the linear reciprocating drive apparatus for a secondary battery manufacturing process according to one aspect of the present disclosure, the first and second magnet members may be electromagnets, the linear reciprocating drive apparatus may include a first control unit configured to generate a magnetic force that generates a repulsive force on the first magnet member or the second magnet member when the third magnet member approaches any one of the first and second magnet members, and the first control unit may perform control so that the magnetic force of the first magnet member or the second magnet member is eliminated when the third magnet member comes into contact with the first magnet member or the second magnet member.

In the linear reciprocating drive apparatus for a secondary battery manufacturing process according to one aspect of the present disclosure, the shock absorbing unit may include: a guide body disposed outside the cylinder and having a column-shaped space formed in a direction parallel to the accommodation portion, the guide body having fourth and fifth magnet members disposed at one end and the other end of the column-shaped space and having different polarities; a sixth magnet member accommodated in the column-shaped space of the guide body, the sixth magnet member being disposed to have the same polarity as the fourth magnet member in a direction in which the sixth magnet member faces the fourth magnet member, and disposed to have the same polarity as the fifth magnet member in a direction in which the sixth magnet member faces the fifth magnet member; and a connection part configured to connect the sixth magnet member and the driving shaft so that the sixth magnet member linearly reciprocates in the guide body in conjunction with a linear reciprocating motion of the driving shaft.

In the linear reciprocating drive apparatus for a secondary battery manufacturing process according to one aspect of the present disclosure, the guide body including the fourth, fifth, and sixth magnet members and the connection part may be provided in plural, and the plurality of guide bodies may be disposed along an outer periphery of the cylinder.

In the linear reciprocating drive apparatus for a secondary battery manufacturing process according to one aspect of the present disclosure, the guide body may have a shape having an annular cross-section that surrounds an outer portion of the cylinder.

In the linear reciprocating drive apparatus for a secondary battery manufacturing process according to one aspect of the present disclosure, the guide body may include a plurality of partition guides configured to divide the inside of the guide body into multiple sections in a direction in which the multiple sections surround the outer portion of the cylinder, and the plurality of partition guides may each have the fourth, fifth, and sixth magnet members and the connection part.

In the linear reciprocating drive apparatus for a secondary battery manufacturing process according to one aspect of the present disclosure, the shock absorbing unit may include second elastic members configured to fix the fourth and fifth magnet members to one end and the other end of the column-shaped space of the guide body based on the longitudinal direction.

In the linear reciprocating drive apparatus for a secondary battery manufacturing process according to one aspect of the present disclosure, the fourth and fifth magnet members may be electromagnets, the linear reciprocating drive apparatus may include a second control unit configured to generate a magnetic force that generates a repulsive force on the fourth magnet member or the fifth magnet member when the sixth magnet member approaches any one of the fourth and fifth magnet members, and the second control unit may perform control so that the magnetic force of the fourth magnet member or the fifth magnet member is eliminated when the sixth magnet member comes into contact with the fourth magnet member or the fifth magnet member.

### Advantageous Effects

According to the present disclosure, the shock absorbing unit may mitigate shock and friction with the inner wall of the cylinder when the piston linearly reciprocates, which makes it possible to obtain a low-noise long-life effect and enable a high-speed linear reciprocating motion.

According to the present disclosure, it is possible to improve the shock absorbing effect of the shock absorbing unit by using the first and second elastic members.

According to the present disclosure, it is possible to minimize a loss of linear reciprocating driving power of the piston by using the first and second control units.

### BRIEF DESCRIPTION OF THE DRAWINGS

FIG. 1 is a view illustrating a first embodiment of a linear reciprocating drive apparatus for a secondary battery manufacturing process according to the present disclosure.

FIG. 2 is a view illustrating a second embodiment of the linear reciprocating drive apparatus for a secondary battery manufacturing process according to the present disclosure.

FIG. 3 is a view illustrating a third embodiment of the linear reciprocating drive apparatus for a secondary battery manufacturing process according to the present disclosure.

FIG. 4 is a view illustrating a fourth embodiment of the linear reciprocating drive apparatus for a secondary battery manufacturing process according to the present disclosure.

FIG. 5 is a view illustrating a fifth embodiment of the linear reciprocating drive apparatus for a secondary battery manufacturing process according to the present disclosure.

FIG. 6 is a view illustrating a sixth embodiment of the linear reciprocating drive apparatus for a secondary battery manufacturing process according to the present disclosure.

FIG. 7 is a view illustrating a seventh embodiment of the linear reciprocating drive apparatus for a secondary battery manufacturing process according to the present disclosure.

FIG. 8 is a view illustrating an eighth embodiment of the linear reciprocating drive apparatus for a secondary battery manufacturing process according to the present disclosure.

FIG. 9 is a view illustrating a ninth embodiment of the linear reciprocating drive apparatus for a secondary battery manufacturing process according to the present disclosure.

### DETAILED DESCRIPTION

Hereinafter, embodiments of a linear reciprocating drive apparatus for a secondary battery manufacturing process according to the present disclosure will be described in detail with reference to the drawings.

However, it should be noted that the intrinsic technical spirit of the present disclosure is not limited by the following exemplary embodiment, and the following exemplary embodiment may easily be substituted or altered by those skilled in the art based on the intrinsic technical spirit of the present disclosure.

In addition, the terms used herein are selected for convenience of description and should be appropriately interpreted as a meaning that conform to the technical spirit of the present disclosure without being limited to a dictionary meaning when recognizing the intrinsic technical spirit of the present disclosure.

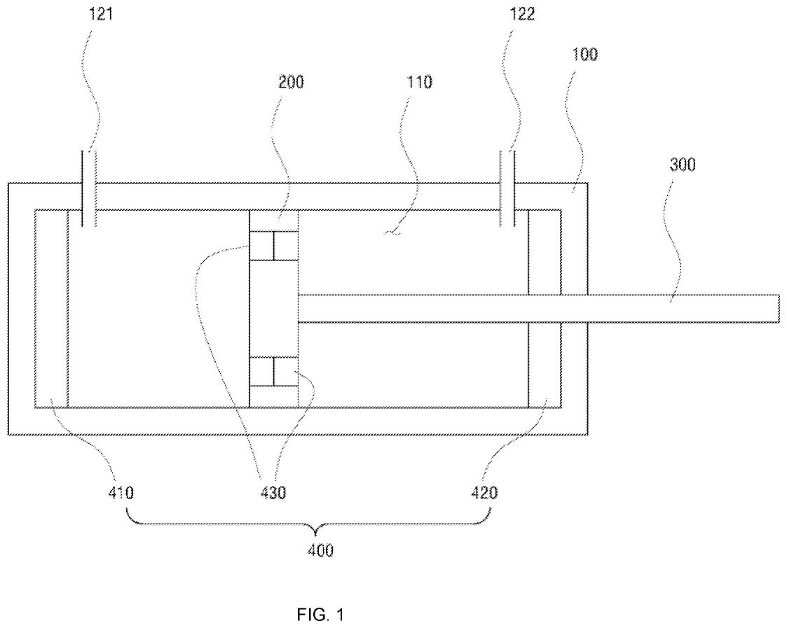

FIG. 1 is a view illustrating a first embodiment of a linear reciprocating drive apparatus for a secondary battery manufacturing process according to the present disclosure.

Referring to FIG. 1, a linear reciprocating drive apparatus for a secondary battery manufacturing process according to the present disclosure includes a cylinder 100, a piston 200, a driving shaft 300, and a shock absorbing unit 400.

The cylinder 100 has therein a column-shaped accommodation portion 110, and first and second air vents 121 and 122 are disposed at one side and the other side of the cylinder 100 and communicate with the accommodation portion.

The piston 200 is disposed in the cylinder 100 and reciprocates between one end and the other end of the accommodation portion 110. The piston 200 divides the accommodation portion 110 into two spaces that communicate with the first and second air vents 121 and 122, respectively.

The driving shaft 300 is connected to the piston 200 and extends to the outside of the cylinder 100. The driving shaft 300 linearly reciprocates as the piston 200 reciprocates in a longitudinal direction of the accommodation portion 110.

The shock absorbing unit 400 absorbs shock by using repulsive forces between magnetic elements when the piston 200 moves toward one end and the other end of the accommodation portion 110.

In the linear reciprocating drive apparatus for a secondary battery manufacturing process according to the present embodiment, the shock absorbing unit 400 particularly includes first and second magnet members 410 and 420 and third magnet members 430.

The first and second magnet members 410 and 420 are respectively disposed at one end and the other end based on the longitudinal direction of the accommodation portion 110 and have poles having different polarities and facing each other.

The third magnet member 430 is provided on the piston 200. In addition, the third magnet member 430 is disposed to have the same polarity as the first magnet member 410 in a direction in which the third magnet member 430 faces the first magnet member 410, and disposed to have the same polarity as the second magnet member 420 in a direction in which the third magnet member 430 faces the second magnet member 420.

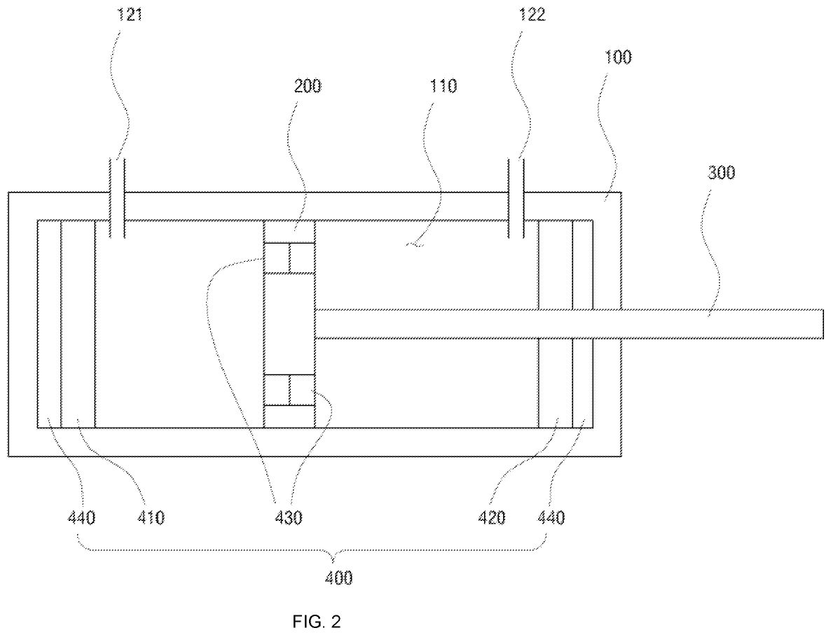

FIG. 2 is a view illustrating a second embodiment of the linear reciprocating drive apparatus for a secondary battery manufacturing process according to the present disclosure.

Referring to FIG. 2, in the linear reciprocating drive apparatus for a secondary battery manufacturing process according to the present embodiment, the shock absorbing unit 400 further includes first elastic members 440 configured to respectively fix the first and second magnet members 410 and 420 to one end and the other end of the accommodation portion 110 based on the longitudinal direction of the accommodation portion 110.

Therefore, it is possible to improve the effect of absorbing shock by using elastic forces of the first elastic members 440 in addition to the repulsive forces between the first and second magnet members 410 and 420 and the third magnet member 430.

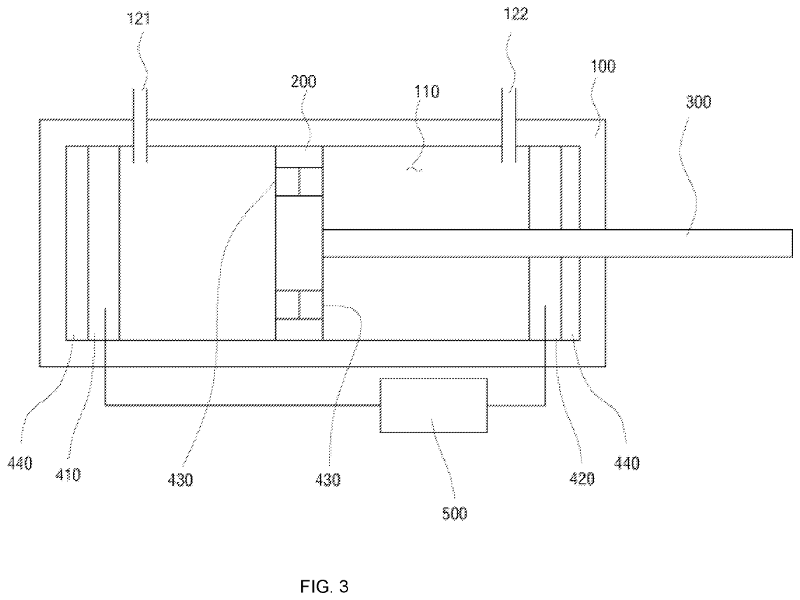

FIG. 3 is a view illustrating a third embodiment of the linear reciprocating drive apparatus for a secondary battery manufacturing process according to the present disclosure.

Referring to FIG. 3, the linear reciprocating drive apparatus for a secondary battery manufacturing process according to the present embodiment includes a first control unit 500 configured to control the repulsive force between the first and second magnet members 410 and 420. The first and second magnet members 410 and 420 are electromagnets controlled by the first control unit 500.

The first control unit 500 generates a magnetic force that generates the repulsive force on the first magnet member 410 or a second magnet member 420 when the third magnet member 430 approaches any one of the first and second magnet members 410 and 420.

In addition, the first control unit 500 performs control so that the magnetic force of the first magnet member 410 or the second magnet member 420 is eliminated when the third magnet member 430 comes into contact with the first magnet member 410 or the second magnet member 420.

Therefore, it is possible to prevent driving power generated by the driving shaft from being decreased by the repulsive forces between the first and second magnet members 410 and 420 and the third magnet member 430.

The linear reciprocating drive apparatus according to the present disclosure is adopted to various unit processes in the secondary battery manufacturing process and provides linear reciprocating driving power.

Therefore, the reciprocating driving power generated by the piston 200 need not be decreased when the amount of shock applied to the piston 200 and the cylinder 100 is reduced by the operation of the shock absorbing unit 400.

For example, it is assumed that the linear reciprocating drive apparatus according to the present disclosure is adopted to a sealing apparatus for sealing a pouch foil for a secondary battery by pressing the pouch foil.

When pushing power for pressing the pouch foil is decreased by the operation of the shock absorbing unit 400, sealing quality of the pouch foil may deteriorate. This may cause severe defects of a large number of manufactured secondary batteries.

The linear reciprocating drive apparatus for a secondary battery manufacturing process according to the present embodiment may use the first control unit 500 and quantitatively control a shock absorbing function of the shock absorbing unit 400 depending on positions of the piston, thereby minimizing a loss of reciprocating driving power of the piston.

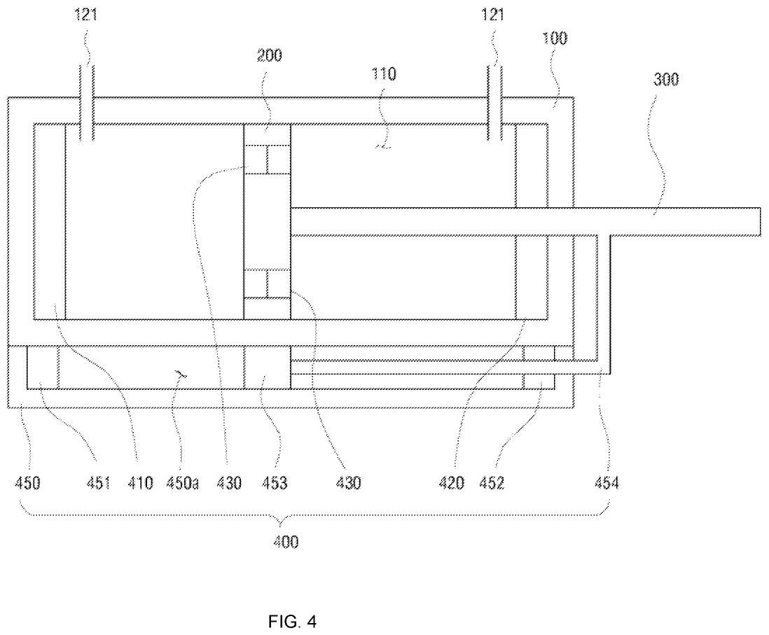

FIG. 4 is a view illustrating a fourth embodiment of the linear reciprocating drive apparatus for a secondary battery manufacturing process according to the present disclosure.

In the linear reciprocating drive apparatus for a secondary battery manufacturing process according to the present embodiment, the shock absorbing unit 400 includes a guide body 450, a sixth magnet member 453, and a connection part 454.

The guide body 450 is provided outside the cylinder 100 and has a column-shaped space 450a formed in a direction parallel to the accommodation portion 110. Fourth and fifth magnet members 451 and 452 having different polarities are respectively disposed at one end and the other end of the column-shaped space 450a.

The sixth magnet member 453 is accommodated in the column-shaped space 450a of the guide body 450. The sixth magnet member 453 is disposed to have the same polarity as the fourth magnet member 451 in a direction in which the sixth magnet member 453 faces the fourth magnet member 451, and disposed to have the same polarity as the fifth magnet member 452 in a direction in which the sixth magnet member 453 faces the fifth magnet member 452.

The connection part 454 connects the sixth magnet member 453 and the driving shaft 300 so that the sixth magnet member 453 linearly reciprocates in the guide body 450 in conjunction with the linear reciprocating motion of the driving shaft 300.

The linear reciprocating drive apparatus for a secondary battery manufacturing process according to the present embodiment may use the guide body 450 having the fourth, fifth, and sixth magnet members 451, 452, and 453, thereby further improving the shock absorbing function implemented by the shock absorbing unit 400.

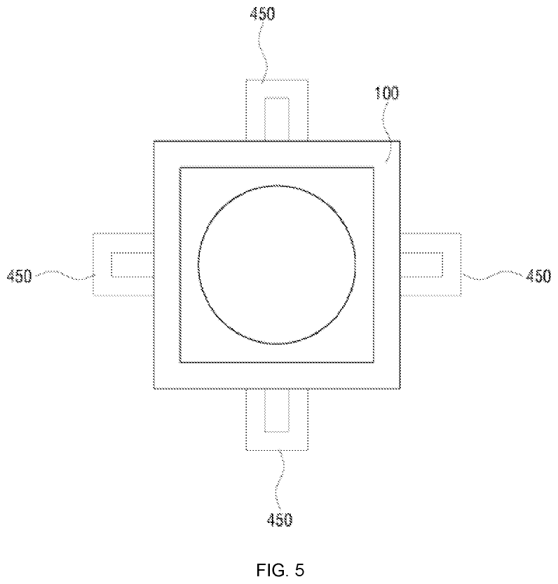

FIG. 5 is a view illustrating a fifth embodiment of the linear reciprocating drive apparatus for a secondary battery manufacturing process according to the present disclosure.

In the linear reciprocating drive apparatus for a secondary battery manufacturing process according to the present embodiment, the guide body 450 having the fourth, fifth, and sixth magnet members 451, 452, and 453 and the connection part 454 may be provided in plural, and the plurality of guide bodies 450 is disposed along an outer periphery of the cylinder 100.

Therefore, it is possible to obtain the sufficient shock absorbing effect by using the pluralities of fourth, fifth, and sixth magnet members 451, 452, and 453 even though the magnetic forces of the fourth, fifth, and sixth magnet members 451, 452, and 453 are relatively low.

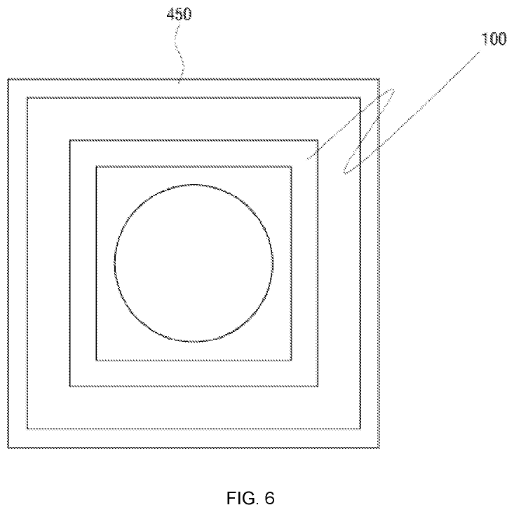

FIG. 6 is a view illustrating a sixth embodiment of the linear reciprocating drive apparatus for a secondary battery manufacturing process according to the present disclosure.

Referring to FIG. 6, in the linear reciprocating drive apparatus for a secondary battery manufacturing process according to the present embodiment, the guide body 450 has a shape having an annular cross-section that surrounds an outer portion of the cylinder 100.

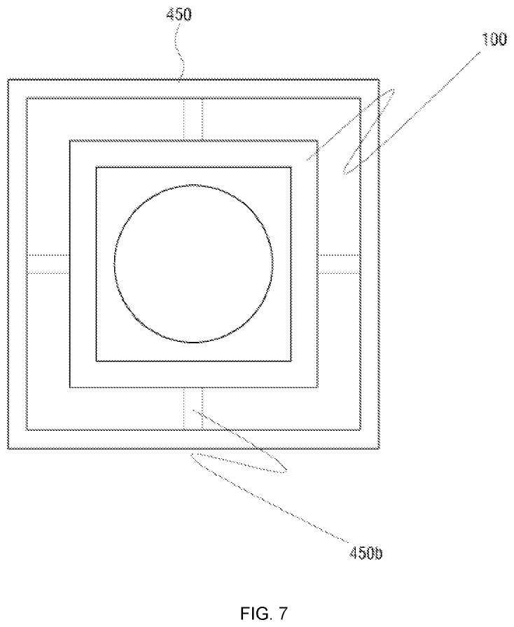

In addition, FIG. 7 is a view illustrating a seventh embodiment of the linear reciprocating drive apparatus for a secondary battery manufacturing process according to the present disclosure.

Referring to FIG. 7, in the linear reciprocating drive apparatus for a secondary battery manufacturing process according to the present embodiment, the guide body 450 has a plurality of partition guides 450b that divides the inside of the guide body 450 into multiple sections in a direction in which the multiple sections surround the outer portion of the cylinder 100. Further, the plurality of partition guides 450b each has the fourth, fifth, and sixth magnet members 451, 452, and 453 and the connection part 454.

Referring to FIGS. 6 to 7, a cross-sectional area of the guide main body 450 increases, such that areas of the fourth, fifth, and sixth magnet members 451, 452, and 453 increase. When the areas of the fourth, fifth, and sixth magnet members 451, 452, and 453 increase, it is possible to the sufficient shock absorbing effect even though the magnetic forces of the fourth, fifth, and sixth magnet members 451, 452, and 453 are relatively low.

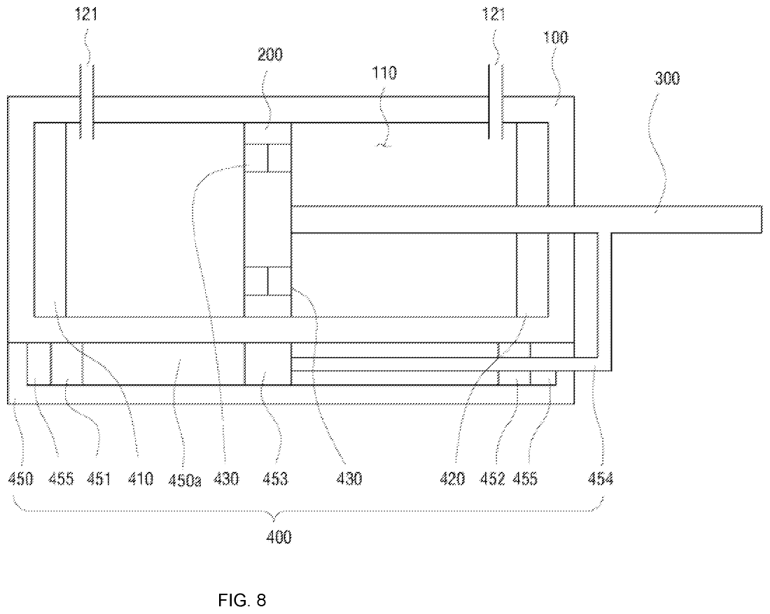

FIG. 8 is a view illustrating an eighth embodiment of the linear reciprocating drive apparatus for a secondary battery manufacturing process according to the present disclosure.

Referring to FIG. 8, in the linear reciprocating drive apparatus for a secondary battery manufacturing process, the shock absorbing unit 400 includes second elastic members 455 configured to respectively fix the fourth and fifth magnet members 451 and 452 to one end and the other end of the column-shaped space 450a of the guide body 450 based on the longitudinal direction.

Therefore, the shock absorbing effect of the shock absorbing unit 400 may be further improved by elastic forces of the second elastic members 455.

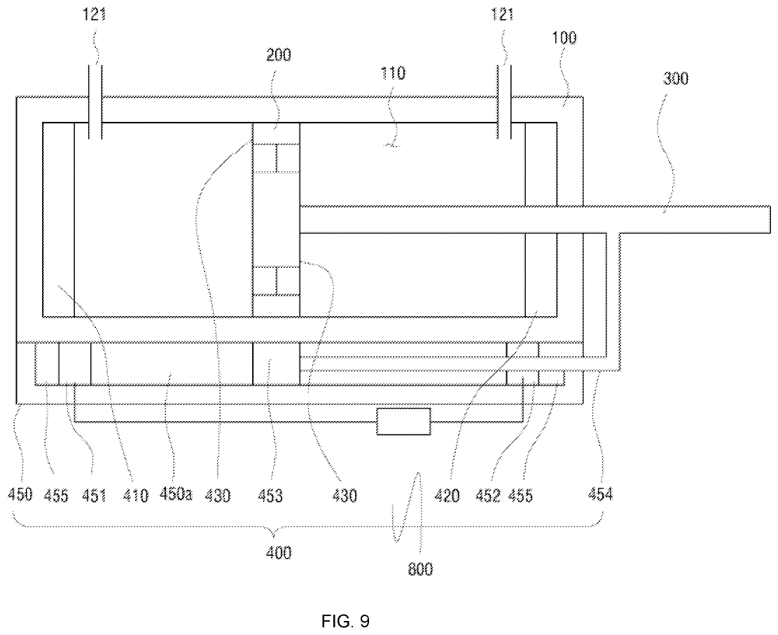

FIG. 9 is a view illustrating a ninth embodiment of the linear reciprocating drive apparatus for a secondary battery manufacturing process according to the present disclosure.

Referring to FIG. 9, the linear reciprocating drive apparatus for a secondary battery manufacturing process according to the present embodiment has a second control unit 800, and the fourth and fifth magnet members 451 and 452 are electromagnets.

The second control unit 800 generates a magnetic force that generates the repulsive force on the fourth magnet member 451 or the fifth magnet member 452 when the sixth magnet member 453 approaches any one of the fourth and fifth magnet members 451 and 452.

In addition, the second control unit 800 performs control so that the magnetic force of the fourth magnet member 451 or the fifth magnet member 452 is eliminated when the sixth magnet member 453 comes into contact with the fourth magnet member 451 or the fifth magnet member 452.

Because the function of the second control unit 800 is identical to the function of the first control unit 500, a detailed description thereof will be omitted.

1. A linear reciprocating drive apparatus for a secondary battery manufacturing process, the linear reciprocating drive apparatus comprising:
a cylinder having therein a column-shaped accommodation portion and including first and second air vents respectively disposed at one side and the other side of the cylinder and configured to communicate with the accommodation portion;
a piston disposed in the cylinder and configured to reciprocates between one end and the other end of the accommodation portion, the piston being configured to divide the accommodation portion into two spaces respectively communicating with the first and second air vents;
a driving shaft connected to the piston and extending to the outside of the cylinder, the driving shaft being configured to linearly reciprocate as the piston reciprocates in a longitudinal direction of the accommodation portion; and
a shock absorbing unit configured to absorb shock by using a repulsive force between magnetic elements when the piston moves toward one end and the other end of the accommodation portion.

2. The linear reciprocating drive apparatus of claim 1, wherein the shock absorbing unit comprises:
first and second magnet members respectively disposed at one end and the other end based on the longitudinal direction of the accommodation portion and having poles having different polarities and facing each other; and
a third magnet member provided on the piston, the third magnet member being disposed to have the same polarity as the first magnet member in a direction in which the third magnet member faces the first magnet member, and disposed to have the same polarity as the second magnet member in a direction in which the third magnet member faces the second magnet member.

3. The linear reciprocating drive apparatus of claim 2, wherein the shock absorbing unit comprises first elastic members configured to fix the first and second magnet members to one end and the other end of the accommodation portion based on the longitudinal direction.

4. The linear reciprocating drive apparatus of claim 2,
wherein the first and second magnet members are electromagnets, the linear reciprocating drive apparatus comprises a first control unit configured to generate a magnetic force that generates a repulsive force on the first magnet member or the second magnet member when the third magnet member approaches any one of the first and second magnet members, and the first control unit performs control so that the magnetic force of the first magnet member or the second magnet member is eliminated when the third magnet member comes into contact with the first magnet member or the second magnet member.

5. The linear reciprocating drive apparatus of claim 1, wherein the shock absorbing unit comprises:
a guide body disposed outside the cylinder and having a column-shaped space formed in a direction parallel to the accommodation portion, the guide body having fourth and fifth magnet members disposed at one end and the other end of the column-shaped space and having different polarities;
a sixth magnet member accommodated in the column-shaped space of the guide body, the sixth magnet member being disposed to have the same polarity as the fourth magnet member in a direction in which the sixth magnet member faces the fourth magnet member, and disposed to have the same polarity as the fifth magnet member in a direction in which the sixth magnet member faces the fifth magnet member; and
a connection part configured to connect the sixth magnet member and the driving shaft so that the sixth magnet member linearly reciprocates in the guide body in conjunction with a linear reciprocating motion of the driving shaft.

6. The linear reciprocating drive apparatus of claim 5, wherein the guide body comprising the fourth, fifth, and sixth magnet members and the connection part is provided in plural, and the plurality of guide bodies is disposed along an outer periphery of the cylinder.

7. The linear reciprocating drive apparatus of claim 5, wherein the guide body has a shape having an annular cross-section that surrounds an outer portion of the cylinder.

8. The linear reciprocating drive apparatus of claim 7, wherein the guide body comprises a plurality of partition guides configured to divide the inside of the guide body into multiple sections in a direction in which the multiple sections surround the outer portion of the cylinder, and the plurality of partition guides each has the fourth, fifth, and sixth magnet members and the connection part.

9. The linear reciprocating drive apparatus of claim 5, wherein the shock absorbing unit comprises second elastic members configured to fix the fourth and fifth magnet members to one end and the other end of the column-shaped space of the guide body based on the longitudinal direction.

10. The linear reciprocating drive apparatus of claim 5,
wherein the fourth and fifth magnet members are electromagnets, the linear reciprocating drive apparatus comprises a second control unit configured to generate a magnetic force that generates a repulsive force on the fourth magnet member or the fifth magnet member when the sixth magnet member approaches any one of the fourth and fifth magnet members, and the second control unit performs control so that the magnetic force of the fourth magnet member or the fifth magnet member is eliminated when the sixth magnet member comes into contact with the fourth magnet member or the fifth magnet member.
